(19) United States
(12) Patent Application Publication
(10) Pub. No.: US 2025/0124905 A1
(43) Pub. Date: Apr. 17, 2025

(54) MULTI-DIMENSIONAL TOUCH CONTROLLER WITH RECONFIGURABLE PAD DIMENSIONS

(71) Applicant: Roger LINN, Los Altos, CA (US)

(72) Inventor: Roger LINN, Los Altos, CA (US)

(21) Appl. No.: 18/751,570

(22) Filed: Jun. 24, 2024

Related U.S. Application Data
(60) Provisional application No. 63/510,826, filed on Jun. 28, 2023.

(51) Int. Cl. G10H 1/34; G10H 1/00

(52) U.S. Cl. CPC G10H 1/34; G10H 1/0008; G10H 1/0066; G10H 2220/161; G10H 2220/271; G10H 2240/311

(57) ABSTRACT

A multi-dimensional touch controller, e.g., a musical instrument controller, provides for selectable pad dimensions. The controller includes a matrix sensor for detecting, measuring, and tracking touch gestures. The sensor includes force-sensing resistors arranged in rows and columns. Intersections of the rows and columns are cells that define a unit pad size. The minimum pad size is 1×1 cell. Double width and/or double length pads can be defined by electrically connecting adjacent columns and/or rows, e.g., to define large 2×2-cell pads, tall 2×1-cell pads, and wide 1×2-cell pads. The electrical connections can be implemented using pairs of multiplexers that allow pairs of rows and/or columns to be selected at once. Virtual pads can be derived in software from switch-defined pads to mitigate a ghost-touch issue characteristic of matrix sensors that otherwise can be exacerbated in certain split configurations with both small and large pads.

### BACKGROUND

Pressure and velocity-sensitive finger-play pads that sense a single touch (hereinafter referred to as “pads”) have been used as musical-instrument interfaces since they were included on the Linn Electronics “Linn 9000” drum machine in 1984 and designed by Roger Linn and popularized on the Akai MPC60 drum machine in 1988, also designed by Roger Linn. The pads on the MPC60 are arranged in a 4×4 array and are large enough for finger drumming, approximately 1.25 inches square and spaced 1.5 inches center to center. Since the MPC60 could create samples and assign them to the pads, the pads could trigger sounds other than drum sounds, e.g., pitched notes and chords. However, those desiring to play complex melodies and finger chords were limited by the number of pads (16) and the large spacings between non-adjacent pads.

In 2014, Roger Linn Design introduced the LinnStrument MIDI Controller, designed to play musical notes and chords, with an 8×25 matrix of smaller finger-sized pads, approximately ⅔-inch square and spaced ¾ inches center to center. Also, each pad sensed not only strike velocity and pressure, but also X-axis position and Y-axis position, permitting capture of musical gestures such as vibrato, pitch bends, and continuous loudness and timbre control. The LinnStrument is intended to control an external sound module or computer that generates sound based on the Musical Instrument Digital Interface (MIDI) protocol, augmented in 1998 to permit MIDI Polyphonic Expression (MPE). The original LinnStrument is the subject matter of U.S. Pat. No. 9,779,709, which issued on Oct. 3, 2017, and is entitled POLYPHONIC MULTI-DIMENSIONAL CONTROLLER WITH SENSOR HAVING FORCE-SENSING POTENTIOMETERS. This patent is incorporated in full by reference herein.

The original LinnStrument used a membrane bearing an 8×25 array of pads overlaying a touch sensor as the touch interface for human input. Subsequently, a “backpackable” LinnStrument 128 was introduced with an 8×16 pad array. The use of pads formed on a membrane provides the functionality of separate pads plus several advantages, not the least of which is the ability to implement pitch bends by sliding from one pad of a given musical pitch to an adjacent pad with a different pitch. The playing surface of the pads is designed to match the size of fingers so that the LinnStrument is well-suited to playing complex melodies and fingering a full range of chords. However, the LinnStrument pads are smaller than ideal for finger-style drumming or for accurately pressing a specific location within such location-sensing pads. Accordingly, there is a demand for a LinnStrument-like device that can be switched between larger “drummable” pads and smaller finger-sized pads.

### BRIEF DESCRIPTION OF THE DRAWINGS

FIG. 1 is a schematic diagram of a musical-instrument controller (MIC) with selectable pad dimensions.

FIG. 2 is a gray-scale plan-view rendering of the MIC of FIG. 1.

FIG. 3 is a perspective view of a membrane of the MIC of FIG. 1.

FIG. 4 is a schematic vertical cross section of the MIC of FIG. 1.

FIG. 5 is an exploded view showing the membrane of FIG. 3 and a sensor of FIG. 4.

FIG. 6 is a see-through plan view of the sensor of FIG. 5 showing the positions of spacer dots of a spacer of the sensor of FIG. 4.

FIG. 7A is a gray-scale plan view of the MIC of FIG. 1 showing the vertical alignment of spacer dots of the sensor of FIG. 5 with the membrane of FIG. 3.

FIG. 7B is a diagram of continuous touch gestures on a large pad of the MIC of FIG. 1.

FIG. 8 is an electrical-circuit diagram for the MIC of FIG. 1.

FIG. 9 is a schematic diagram showing an addressing scheme for the MIC of FIG. 1 when a small (1×1-cell) pad configuration is selected.

FIG. 10 is a schematic diagram showing an addressing scheme for the MIC of FIG. 1 when a large (2×2-cell) pad configuration is selected.

FIG. 11 is a schematic diagram showing an addressing scheme for the controller of FIG. 1 when a tall (2×1-cell) pad configuration is selected.

FIG. 12 is a schematic diagram showing an addressing scheme for the controller of FIG. 1 when a wide (1×2-cell) pad configuration is selected.

FIG. 13 is a flow chart of a process for selecting pad dimensions and using the selected pads.

FIG. 14 represents a small-pad layout with pads at three corners of a rectangle that, when touched can cause a ghost touch to be detected corresponding to a pad at the fourth corner of the rectangle.

FIG. 15 is a perspective view of the membrane of FIG. 3 in a split configuration including large pads (with quadrisecting shallow grooves omitted) on the left and small pads on the right.

FIG. 16 is a schematic planar view of the membrane of FIG. 3 configured with large and small pads as shown in FIG. 15 illustrating the ghost-touch issue.

FIG. 17 is a schematic view of the membrane of FIG. 3 configured with switch-defined large pads on the left and virtual small pads on the left derived from switch-defined tall pads on the right in the context of a static tall-pad approach to mitigating the ghost-touch issue indicated in FIG. 16.

FIG. 18 is a schematic view of the membrane of FIG. 3 configured with switch-defined large pads on the left and virtual small pads on the left derived from switch-defined tall pads on the right in the context of a dynamic tall-pad approach to mitigating the ghost-touch issue indicated in FIG. 16.

FIG. 19 is a schematic view of the membrane of FIG. 3 configured with small pads on the right and virtual large pads based on switch-defined wide pads in the context of a wide-pad approach to mitigating the ghost-touch issue.

FIG. 20 is a schematic illustration of the musical instrument controller of FIG. 1 from a computer science perspective.

### DETAILED DESCRIPTION

The present invention provides for selecting pad dimensions by switching between addressing single vs adjacent sensor rows and/or columns of a matrix sensor. For example, a small (1×1-cell) single-touch pad can be addressed by selecting a single row and a single column, while a large (2×2-cell) single-touch pad can be addressed by selecting a pair of adjacent rows and a pair of adjacent columns. As explained further below, tall (2×1-cell) single-touch pads and wide (1×2-cell) single-touch pads can be selected in some embodiments. In addition, virtual pads can be derived in software from the foregoing switch-defined pads. These variable-size and virtual pads mitigate a ghost touch problem that is inherent in such a matrix sensor design, especially if mixed pad-size configurations are configured in the touch surface.

Other aspects of the invention include: 1) a novel interface design to help a player identify boundaries for both small and large pads; and 2) a novel spacer design compatible with both large and small pads. The present invention has applicability to controllers for musical generators such as hardware and software synthesizers using MIDI 1.0 (e.g., augmented by MPE) or 2.0 or other protocols. Such protocols can be used for other purposes, e.g., controlling lighting.

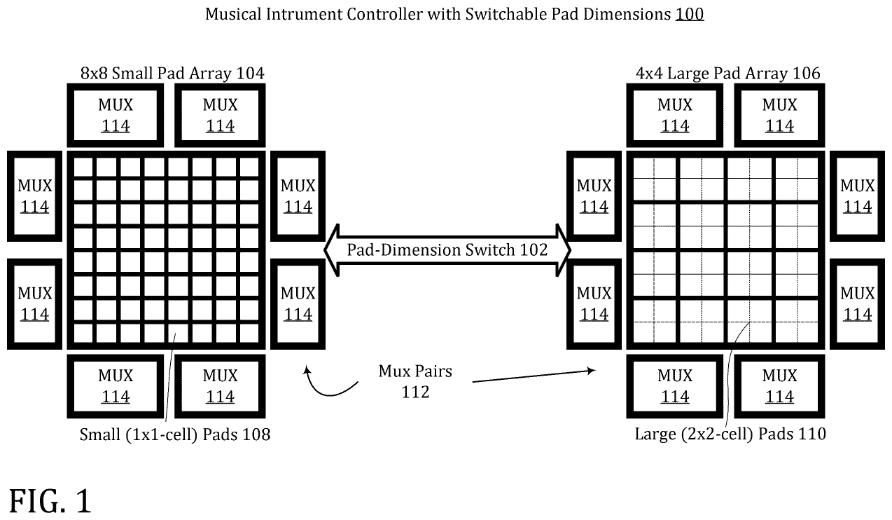

The present invention uses hardware, e.g., analog switches, and software to connect and disconnect analog sensors to implement pad-dimension selection. This approach contrasts with a software-only approach that implements virtual large pads by aggregating touch data from small pads. The hardware and software approach has the advantage of mitigating a “ghost touch” phenomenon: when pads at three corners of a rectangle are touched, a touch is detected at the fourth corner of the rectangle even though a fourth-corner pad is not touched. In a music production context, this can result in the sounding of an unwanted note; in other contexts, other unintended consequences can occur. The ghost touch problem and its solutions are explained in detail after the following description of a hardware-plus-software embodiment with reference to FIGS. 1-13.

Accordingly, a musical instrument controller (MIC) 100 is shown in FIG. 1 being switched (at 102) between an 8×8 small-pad array 104 and a 4×4 large-pad array 106. Small pad array 104 is divided into 64 small (1×1-cell) pads 108, while pad array 106 is divided into 16 large (2×2-cell) pads 110. In other embodiments, there can be different numbers of rows and/or columns. The switching is performed using pairs 112 of multiplexers 114 arranged so that adjacent rows/columns are controlled by different multiplexers. Thus, adjacent rows/columns can be selected when both multiplexers of a pair are enabled. To select single rows/columns, only one multiplexer of each pair is selected. The connections between multiplexers and rows/columns are described further below.

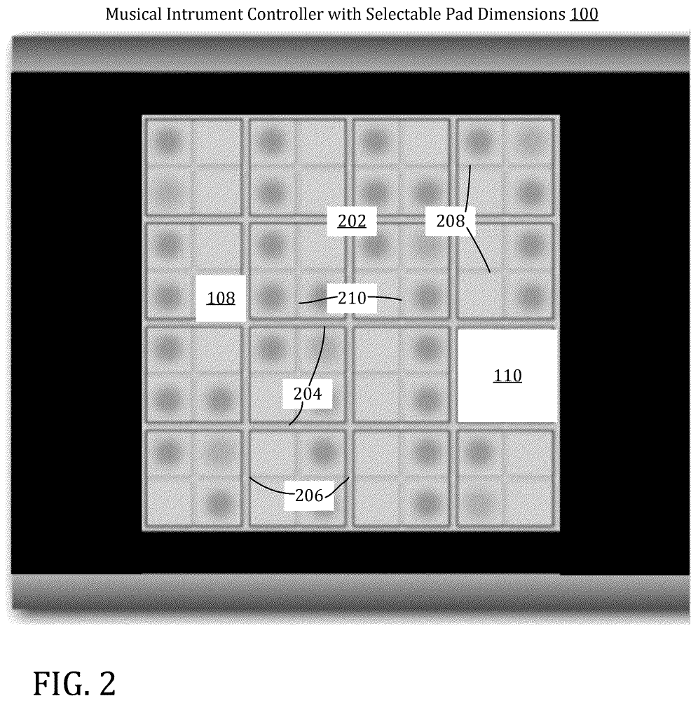

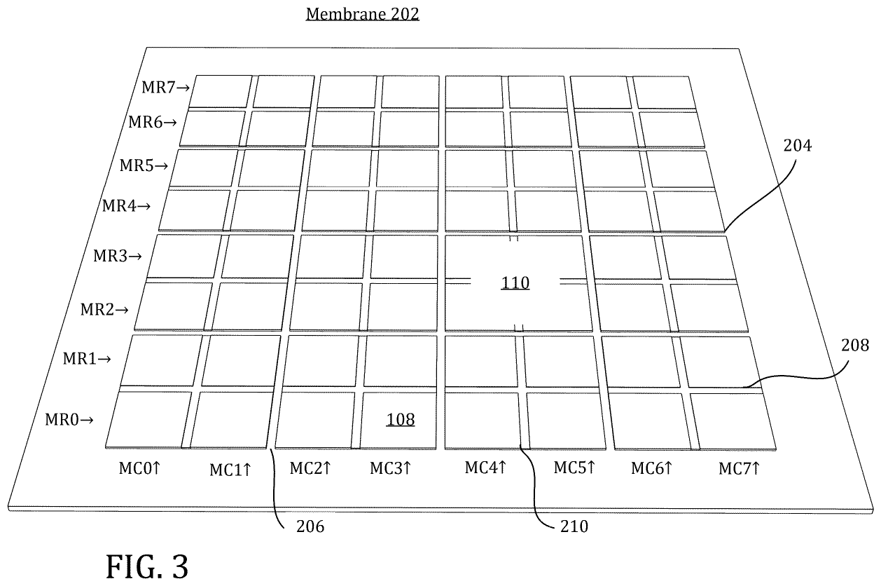

As shown in FIGS. 2 and 3, controller 100 includes a flexible membrane 202 on which large pads 110 are formed, bounded by deep (0.5 mm) horizontal (X-dimension) grooves 204 and deep longitudinal (Y-dimension) grooves 206. Shallow horizontal grooves 208 and shallow longitudinal grooves 210 are formed through large pads 110. Small pads 108 are bounded by both deep and shallow grooves. (The original LinnStrument had only small pads bounded by same-size grooves.) These deep and shallow grooves provide visual and tactile guidance to a player as to locations of the large and small pads. As shown in FIG. 3, small pads 108 are arranged in membrane rows MR0-MR7 and membrane columns MC0-MC7.

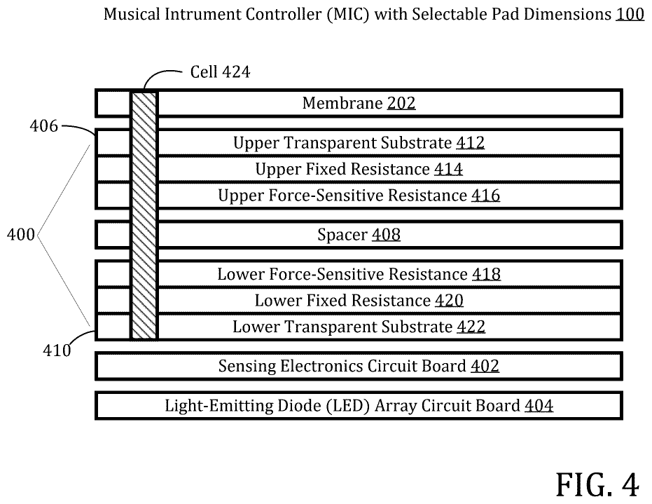

As shown in FIG. 4, membrane 202 is the top layer of a multi-layer structure including a sensor 400, a controller circuit board 402, and a light-emitting diode (LED) circuit board 404. In an alternative embodiment, the LEDs are integrated into the controller circuit board, obviating the need for a separate LED circuit board.

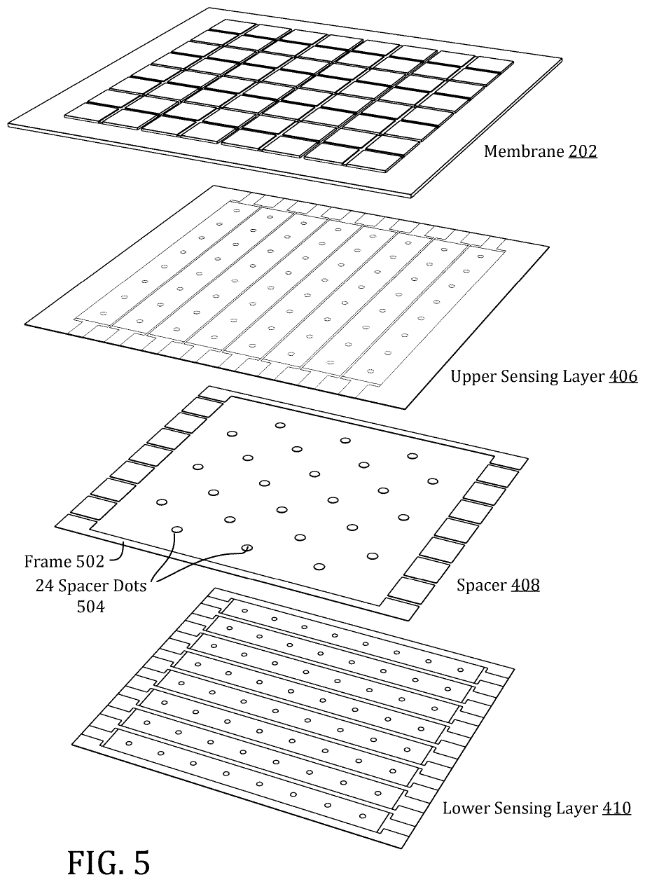

Sensor 400 includes an upper sensing layer 406, a spacer 408, and a lower sensing layer 410, shown in perspective in FIG. 5. As shown in FIG. 4, upper sensing layer 406 includes an upper transparent substrate 412, an upper fixed resistance sublayer 414, and an upper force-sensitive resistance sublayer 416. Lower sensing layer 410 includes a lower force-sensitive resistance sublayer 418, a lower fixed resistance sublayer 420, and a lower transparent substrate 422. Substrate sublayers 412 and 422 can be sheets of transparent heat stable polyester. Fixed-resistance sublayers 414 and 420 can be fixed-resistance ink printed in a pattern on the respective substrate sublayers. Force-sensitive resistance sublayers 416 and 418 can be force-sensitive resistive ink printed onto the respective fixed-resistance sublayers 414 and 420.

As shown in FIG. 5, spacer 408 includes a frame 502 and spacer dots 504. The rectangular spacer frame 502, FIG. 5, surrounds the full touch area. This rectangular frame is interrupted by eight venting channels on each of the left and right sides, permitting air to freely flow in and out when the touch surface is pressed from above. In the center touch area are 24 small round spacer dots that maintain a physical and electrical separation between upper sensing layer 406 and lower sensing layer 410 in the absence of a touch of a pad.

The spacer dots have a radius of 2.5 mm and the thickness including adhesive is 125 micrometer (0.127 mm=0.0005 inches). In other embodiments, the radius, shape and thickness of the spacer dots are different. The spacer dots are specifically placed to permit free touch movements within small zones, large zones, double-wide zones and double-high zones, as well as continuous zone-to-zone slides within a single row or column. This spacer placement provides adequate separation of the upper and lower sensor layers because a touch is never more than the distance of a single touch zone from a spacer dot. These spacer dots are glued or otherwise fixed to upper sensing layer 406 and lower sensing layer 410. In the illustrated embodiment, there are 24 spacer dots; in other embodiments, e.g., with different numbers of rows and/or columns, employ different numbers of spacer dots.

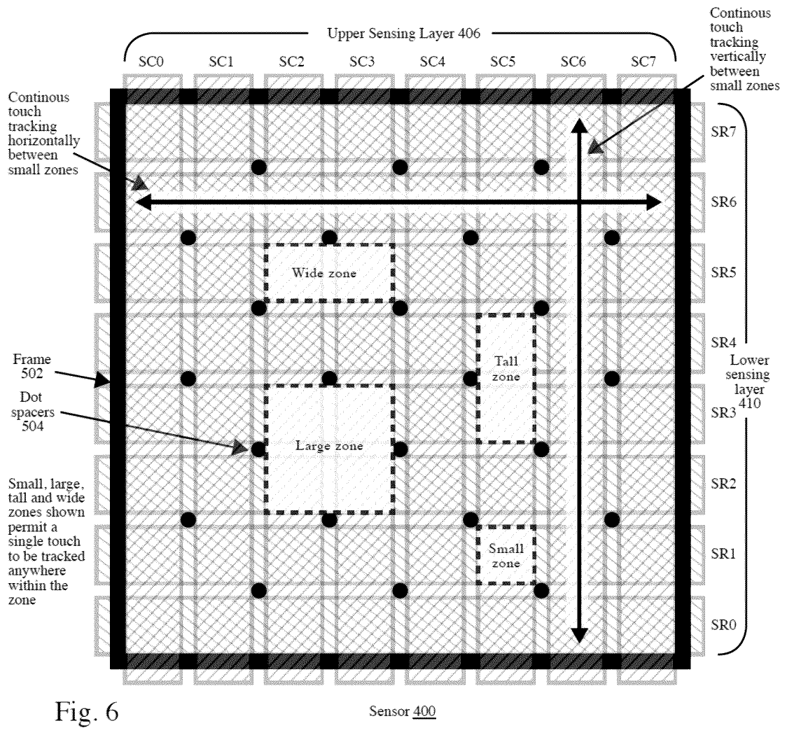

In an alternative embodiment, rails such as those used in the original instrument replace some of the dots shown in FIG. 6. For example, rails between sensor rows SR1 and SR2, between sensor rows SR3 and SR4, and between sensor rows SR5 and SR6 can be implemented. The rails provide additional structural separation of the upper and lower layers but prevent continuous vertical pad-to-pad slides from the frontmost pad to the rearmost pad.

Resistive sublayers 418 and 420 of lower sensing layer 410 are printed in rows to define respective sensor rows SR0-SR7, shown in FIG. 6; sensor rows SR0-SR7 are vertically aligned with membrane rows MR0-MR7 (FIG. 3). Resistive sublayers 414 and 416 of upper sensing layer 406 are printed in columns to form respective sensor columns SC0-SC7 (FIG. 6), which are vertically aligned with membrane rows MC0-MC7 (FIG. 3), respectively. Accordingly, intersections of vertical projections of sensor rows and columns align vertically with respective small pads 108 (FIG. 1). In an alternative embodiment, the columns are on the bottom layer and the rows are on the top layer.

For each sensor row and each sensor column, the respective fixed resistance sublayers 414, 420 (FIG. 4) provide the potentiometer aspect for measuring horizontal (X) and longitudinal (Y) position, while the respective force-sensitive resistance sublayers 416, 418 provide the force sensing for the vertical (Z) dimension. An alternative embodiment omits fixed-resistance sublayers, relying on force-sensing resistance sublayers for both force sensing and position sensing. However, the inclusion of the fixed-resistance sublayers provides for greater accuracy and range in both position and pressure sensing.

In a small pad configuration, pressing a small pad 108 causes the corresponding sensor row and the corresponding column to connect electrically within the corresponding vertically extending cell 424 (FIG. 4). Thus, each small pad serves as the tactile top surface of a respective cell 424. A voltage along a sensor row and output through an intersecting column can determine the fine X-position of a touch within a cell, while a voltage along a sensor column and output via an intersecting row can determine the fine Y-position of a touch within a cell.

Thus, the fine X-and Y-positions of a touch can be determined from potentiometer readings in the touched cell 424. In addition, a z-axis force of the touch can be determined as the combined resistance through the force-sensitive resistance sublayers 416 and 418 in the touched cell 424. This resistance decreases with the force of the touch. The velocity of an initial touch can be determined by rapidly reading the pressure value at high speed, tracking the pressure rise and fall of a fast strike and using the peak pressure value to represent the strike velocity.

As noted above, small pads 108, shown in FIG. 2, can be viewed as the tops of cells 424 (FIG. 4); accordingly, MIC 100 has 64 cells. Each cell 424 is a rectangular parallelepiped extending from the top surface of tactile membrane 202 through sensing layers 406 and 410. In the absence of a touch, sensing layers 406 and 410 are separated and electrically disconnected by spacer 408. However, when a small pad is touched, upper sensing layer 406 and lower sensing layer 410 come into contact in the corresponding cell 424. The contact can be detected, the force causing the contact can be measured electrically, and the location of the touch within the cell can be precisely determined using sensor rows SR0-SR7 and sensor columns SC0-SC7, FIG. 6.

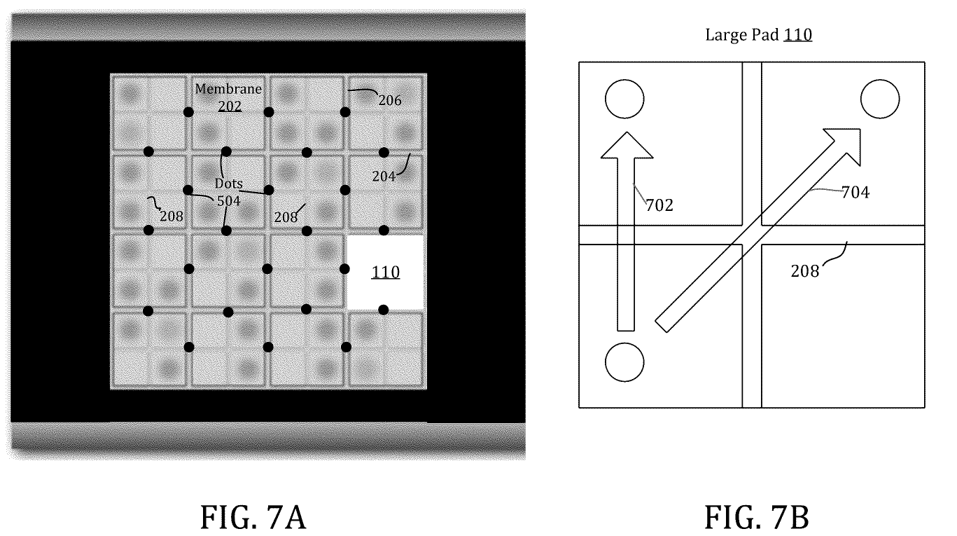

Spacer 408 includes a plastic frame 502 at the spacer perimeter. Spacer dots 504 are located, as shown in FIGS. 6 and 7A, below the intersections of deep grooves 204 and 206 with shallow grooves 208 and 210. As best seen in FIG. 7A, in a large-pad configuration, there are no spacer dots in the interiors of large pads 110, thus allowing vertical gestures 702 and diagonal gestures 704, shown in FIG. 7B, that cross a shallow horizontal groove 208 within a large pad to be continuously tracked. In a small pad configuration, gestures, typically associated with changes in pitch, can be continuously tracked across pad boundaries within a membrane row.

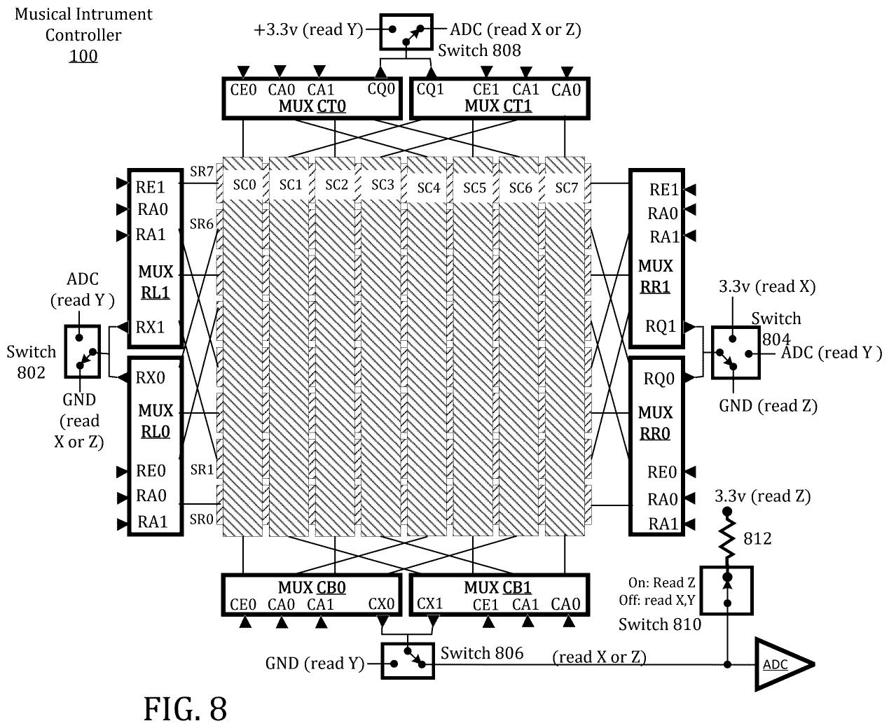

MIC 100 is a three-dimensional continuous controller requiring readout and tracking of X-position, Y-position, and Z-force (aka pressure), all three of which are encoded as voltages by MIC 100 as shown in FIG. 8. MIC 100 includes sensor 400, eight 4:1 analog multiplexers RL0, RL1, RR0, RR1, CT0, CT1, CB0, and CB1, five analog switches 802, 804, 806, 808 and 810, and an analog-to-digital converter ADC, along with connections to a distributed pull-up voltage source and a distributed electrical ground GND. Other embodiments implement voltage differentials other than ground to 3.3 V, e.g., −5 V to +5 V.

Left-row multiplexer RL0 has an enable input RE0, address inputs RA0 and RA1, and an output RX0. When enable input RE0 is active, then address inputs RA0 and RA1 determine which one of four even-numbered sensor rows (SR0, SR2, SR4, or SR6, FIG. 6) is electrically connected to output RX0. When enable input RE0 is inactive, then none of the sensor rows are electrically coupled to multiplexer output RX0. Left-row multiplexer RL1 has an enable input RE1, address inputs RA0 and RA1, and an output RX1. (Inputs with the same label receive the same input signals.) When enable input RE1 is active, then address inputs RA0 and RA1 determine which one of four odd-numbered sensor rows (SR1, SR3, SR5, or SR7, FIG. 6) is electrically connected to output RX1. When enable input RE1 is inactive, then none of the sensor rows are electrically coupled to multiplexer output RX0. When considered as a pair, multiplexers RL0 and RL1 determine which row, or which two adjacent rows are coupled to one or both multiplexer outputs RX0 and RX1.

Right-row multiplexer RR0 has an enable input RE0, address inputs RA0 and RA1, and an output RQ0. When enable input RE0 is active, then address inputs RA0 and RA1 determine which one of four even-numbered rows (SR0, SR2, SR4, or SR6) is electrically connected to output RQ0. When enable input RE0 is inactive, then none of the rows are electrically coupled to multiplexer output RQ0. Right-row multiplexer RL1 has an enable input RE1, address inputs RA0 and RA1, and an output RQ1. When enable input RE1 is active, then address inputs RA0 and RA1 determine which one of four odd-numbered sensor rows (SR1, SR3, SR5, or SR7) is electrically connected to output RQ1. When enable input RE1 is inactive, then none of the sensor rows are electrically coupled to multiplexer output RQ1. When considered as a pair, multiplexers RR0 and RR1 determine which row is or which two adjacent rows are coupled to one or both multiplexer outputs RQ0 and RQ1. Note that multiplexers RL0 and RR0 share the same enable input RE0; likewise, multiplexers RL1 and RR1 share the same enable input RE1. All four row multiplexers RL0, RL1, RR0, and RR1 share the same address inputs RA0 and RA1.

Bottom-column multiplexer CB0 has an enable input CE0, address inputs CA0 and CA1, and an output CX0. When enable input CE0 is active, then address inputs CA0 and CA1 determine which one of four even-numbered sensor columns (SC0, SC2, SC4, or SC6) is electrically connected to output CX0. When enable input CE0 is inactive, then none of the sensor columns are electrically coupled to multiplexer output CX0. Bottom-column multiplexer CB1 has an enable input CE1, address inputs CA0 and CA1, and an output CX1. When enable input CE1 is active, then address inputs CA0 and CA1 determine which one of four odd-numbered sensor columns (SC1, SC3, SC5, or SC7) is electrically connected to output CX1. When enable input CE1 is inactive, then none of the sensor columns are electrically coupled to multiplexer output CX1. When considered as a pair, multiplexers CB0 and CB1 determine which column is or which two adjacent columns are coupled to one or both multiplexer outputs CX0 and CX1.

Top-column multiplexer CT0 has the enable input CE0, address inputs CA0 and CA1, and an output CQ0. When enable input CE0 is active, then address inputs CA0 and CA1 determine which of four even-numbered sensor columns (SC0, SC2, SC4, or SC6) is electrically connected to output CQ0. When enable input CE0 is inactive, then none of the sensor columns are electrically coupled to multiplexer output CQ0. Top-column multiplexer CT1 has an enable input CE1, address inputs CA0 and CA1, and an output CQ1. When enable input CE1 is active, then address inputs CA0 and CA1 determine which one of four odd-numbered sensor columns (SC1, SC3, SC5, or SC7) is electrically connected to output CQ1. When enable input CE1 is inactive, then none of the sensor columns are electrically coupled to multiplexer output CQ1. When considered as a pair, multiplexers CT0 and CT1 determine which sensor column is or which two adjacent sensor columns are coupled to one or both multiplexer outputs CQ0 and CQ1. Note that multiplexers CB0 and CT0 share the same enable input CE0; likewise, multiplexers CB1 and CT1 share the same enable input CE1. All four column multiplexers CB0, CB1, CT0, and CT1 share the same address inputs CA0 and CA1.

Collectively, enable and address inputs RE0, RE1, RA0, RA1, CE0, CE1, CA0, and CA1 determine which pad is addressed at any given time. All pads of the active configuration are scanned to detect touches in the form of non-zero z-force readings. To this end, circuit 800 can be in its Z-read configuration as shown in FIG. 8. In the read-Z configuration, left switch 802 connects multiplexer outputs RX0 and RX1 to ground GND, right switch 802 connects multiplexer outputs RQ0 and RQ1 to ground GND; bottom switch 806 couples multiplexer outputs CX0 and CX1 to analog-to-digital converter ADC; and top switch 808 connects multiplexer outputs CQ0 and CQ1 to analog to digital converter ADC. Switch 810 couples the analog-to-digital converter input to a pull-up voltage, (in this case +3.3 V) via a resistor 812. If no touch is detected, the next pad is addressed. In other embodiments, different pull-up voltages are used, and some embodiments use different electrical configurations with various pull-up or pull-down voltages.

In the event a touch is detected for an addressed pad, repeated frequent Z reads are immediately made to the touched pad in order to capture the rise rate and peak value of the initial strike, from which a velocity value is computed. Then X and Y readings can follow. For an X value read, switch 802 continues to connect multiplexer outputs RX0 and RX1 to ground GND; switch 804 is switched to connect outputs RQ0 and RQ1 to the positive voltage (in this case, +3.3 volts); switch 806 continues to couple outputs CX0 and CX1 to analog-to-digital converter ADC; switch 808 continues to connect output CQ0 and CQ1 to analog-to-digital converter ADC; and switch 810 is switched off to break the connection to the pull-up voltage.

For a Y-value read: switch 802 is switched to connect outputs RX0 and RX1 to analog-to-digital converter ADC; switch 804 is switched to couple outputs RQ0 and RQ1 to analog-to-digital converter ADC; switch 806 is switched to couple multiplexer outputs CX0 and CX1 to ground GND; switch 808 is switched to couple multiplexer outputs CT0 and CT1 to the positive voltage (in this case, +3.3 volts); and switch 810 remains off. Once this set of readings is attained, circuit 800 can continue scanning for detections at other addresses while also periodically scanning the X, Y and Z values of the touched pad for changes in the finger location and pressure. Herein, the term “switches” encompasses elements identified as “multiplexers” in addition to those identified as “switches”.

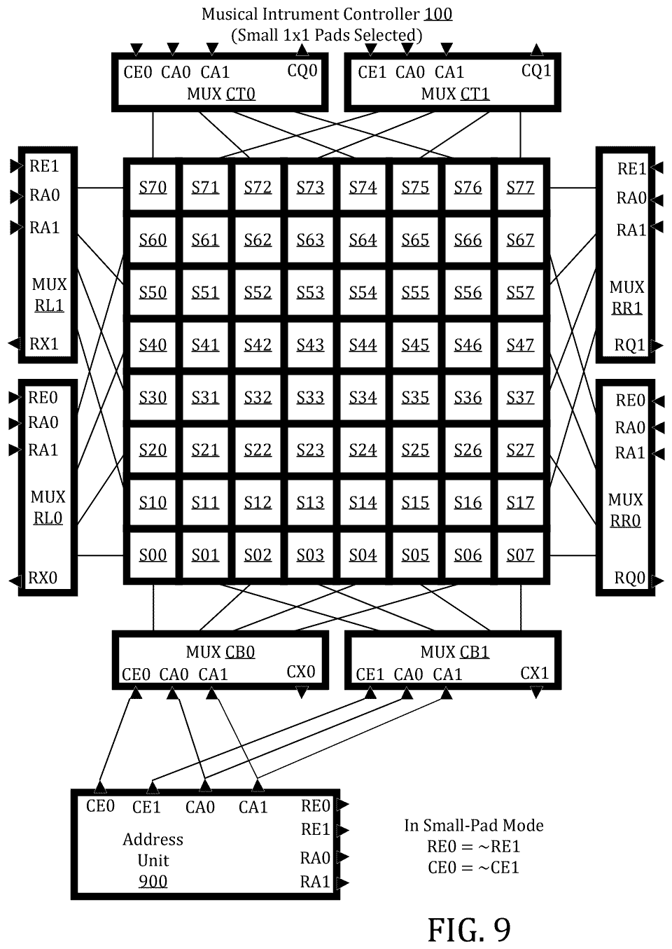

Addressing small (1×1-cell) pads is explained with reference to FIG. 9 in which pads S00-S77 are numbered modulo 8 as “S” for “small” followed by a row number (0-7) and a column number (0-7). To address small pads, only one multiplexer in each pair is selected at a time. Row numbers can be selected in binary form as RA1 RA0, RE1; for example, row R4 can be selected by setting RA1=1, RA0=0, and RE1=0, resulting in binary 100=4. Note that for small-pad addresses, RE0 must always be the opposite state of RE1. Column numbers can be selected in binary as CA1 CA0 CE1; for example, column C5 can be selected by setting CA1=1, CA0=0, and CE1=1, resulting in binary 101=5. Note that for small-pad addresses, CE0 must always be the opposite state of CE1. Thus, address unit 900 can churn out addresses to effect scanning to detect touches and perform XYZ readouts and tracking. Note: address unit can be a component of a micro-processor.

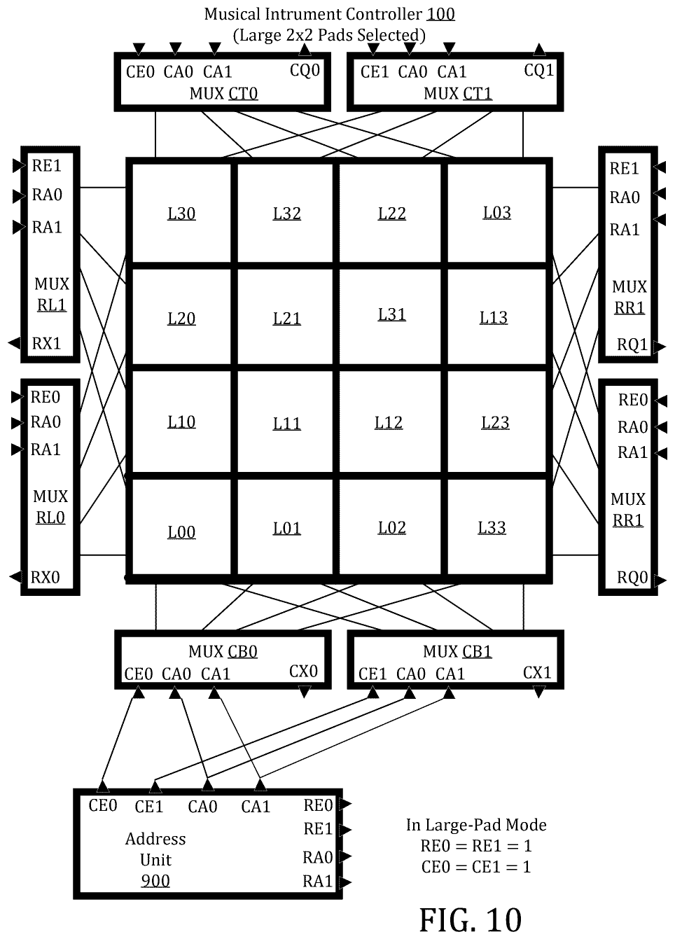

Pad addressing for large (2×2-cell) pads L00-L33 (modulo 4), shown in FIG. 10, requires all multiplexers to be enabled. Enabling both multiplexers of each pair electrically connects adjacent pairs of rows, and electrically connects adjacent pairs of columns. To enable all multiplexers, address unit 900 sets all enable bits RE0, RE1, CE0, and CE1 to “1” (assuming that binary value 1 activates multiplexers). Address values RA0, RA1, CA0, and CA1 are then used to select individual large pads. Address values RA0 and RA1 are used to select among rows LR0-LR3 and values CA0 and CA1 are used to select among columns LC0-LC3. For example, to select large pad L12, (RE0, RE1, RA0 RA1)=(1,1,0,1) and (CE0, CE1, CA0, CA1)=(1,1,1,0).

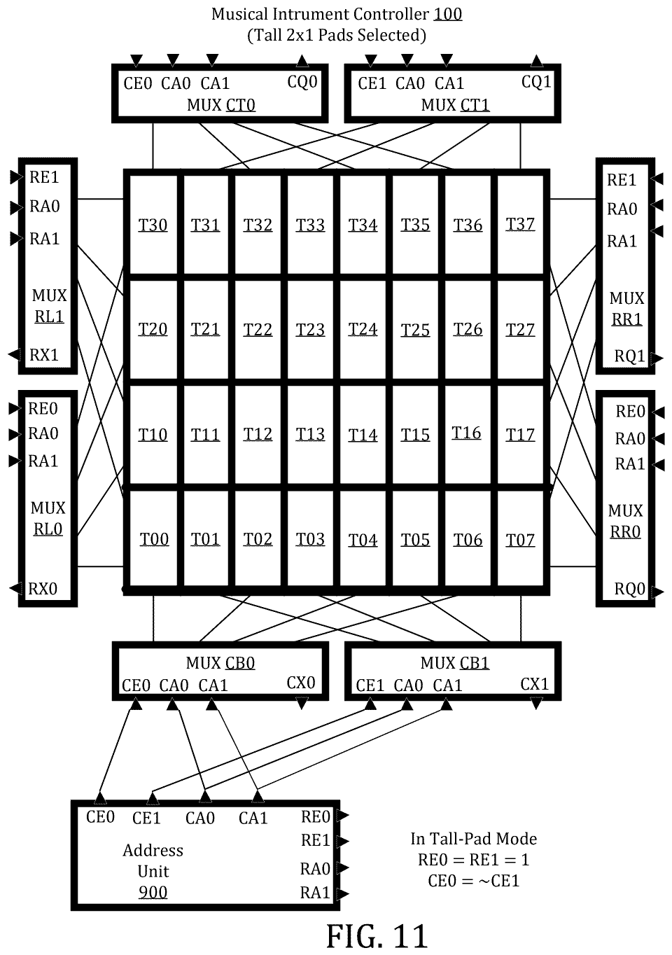

Pad addressing for tall (2×1-cell) pads T00-T37 (modulo 4 for rows and modulo 8 for columns), shown in FIG. 11, requires all row multiplexers RL0, RL1, RR0 and RR1 to be enabled so that adjacent pairs of cell rows are electrically connected. To enable all row multiplexers, address unit 900 sets enable bits RE0 and RE1 to 1 (active), However, only one column multiplexer of each (top, bottom) pair is active at a time. This is accomplished by requiring CE1=1 when CE0=0 and CE1=0 when CE0=1.

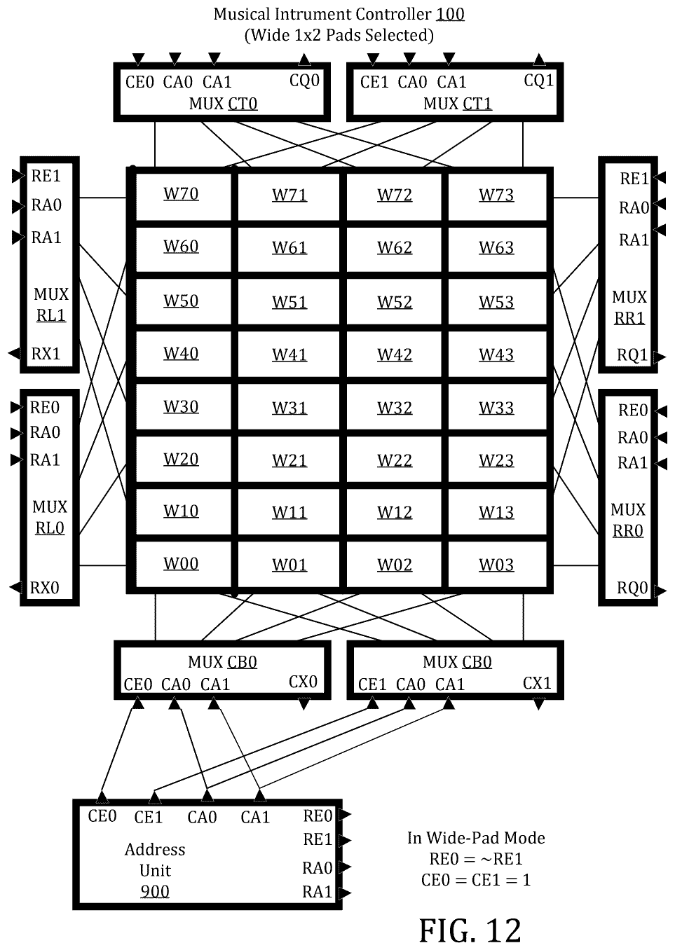

Pad addressing for wide (1×2-cell) pads W00-W73 (modulo 8 for rows, modulo 4 for columns), is shown in FIG. 12. To address eight rows SR0-SR7 (FIG. 6), only one row multiplexer of each (left or right) pair of multiplexers is activated at a time. To this end, RE0=1 and RE1=0 to select even rows (SR0, SR2, SR4, SR6) and RE0=0 and RE1=1 for odd rows (SR1, SR3, SR5, SR7). All column multiplexers CB0, CB1, CT0, and CT1 are activated, in which case enable bits CE0=CE1=1. For example, wide pad W52 can be addressed by setting (RE0, RE1, RA0, RA1) to (0,1,1,0) and (CE0, CE1, CA0, CA1) to (1,1,1,0).

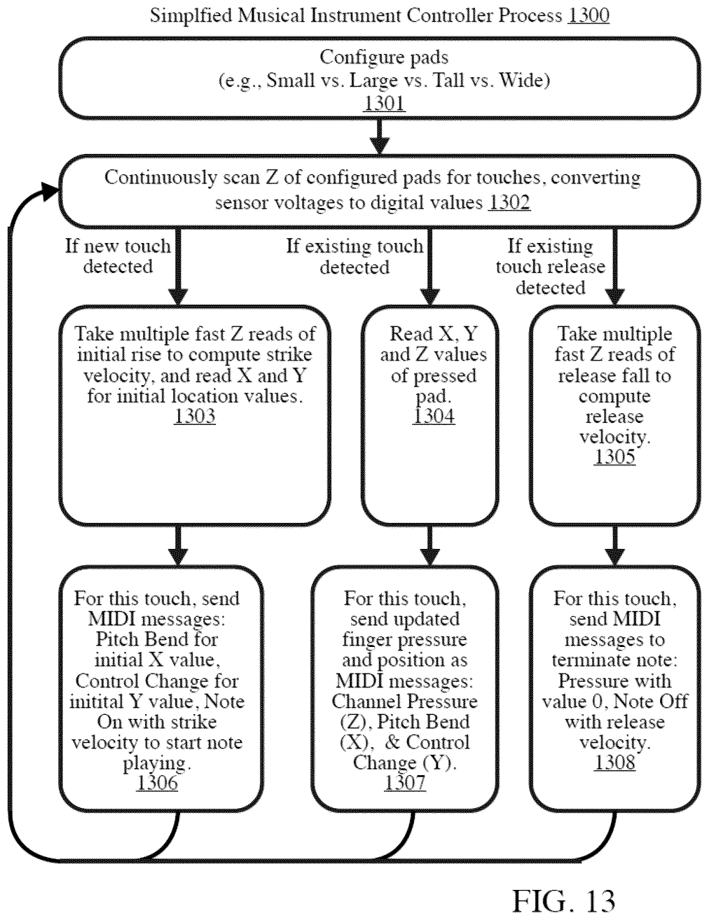

A musical instrument controller process 1300, flowcharted in FIG. 13, can begin with configuring pads at 1301 by selecting among small, large, tall, and wide pads. At 1302, the configured pads are scanned sequentially and continuously to detect touches by reading Z-pressure values.

In the event a new touch is detected at 1302, at 1303 it is processed by taking repeated fast Z measurements to determine a strike velocity value, and initial X and Y positions are also read. Then at 1306, MIDI messages are sent for starting a new musical note with pitch and velocity, for the initial X position, and for the initial Y position. Or if an existing touch is detected in 1302, it is processed at 1304, reading the updated X and Y positions and sending them as updated MIDI X and Y position messages at 1307. Or if the release of an existing touch is detected at 1302, it is processed at 1305, using repeated Z reads as the touch is released to determine the release velocity, which is included in a MIDI message at 1308 to stop the musical note playing.

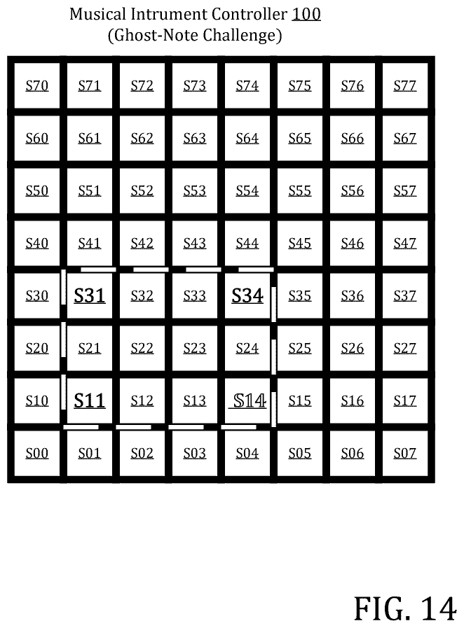

Because the cells are connected in an electrical matrix, a ghost-touch detection problem exists that is common to matrix keyboards: when pads at three corners of a rectangle are touched, an electrical connection is created that results in a “ghost” touch at a pad at the fourth corner. This ghost touch is avoided in some mechanical keyboards by placing a diode in series with each keyboard key; this solution cannot be implemented in sensor 400 (FIG. 4) because the two sensor layers directly touch when pressed from above. Thus, as indicated in FIG. 14, when small pads S11, S31, and S34 are touched concurrently, a ghost touch is detected as if pad S14 were touched whether or not pad S14 is touched. In a musical-instrument context, a ghost touch detection can result in the sounding of an unintended musical note; in other contexts, other errors can result from a ghost touch detection. Accordingly, some approach is desired to avoid or at least minimize musical or other errors resulting from ghost touch detections.

The connections resulting in a ghost touch involve currents through segments of row and column sensors. Specifically, when three pads are pressed that are three corners of a rectangle, an electrical connection is made that causes a pressure reading to appear at the unpressed fourth corner pad that is the same as if it is pressed. (This occurs even though the pads are scanned one at a time, because the touches are held continuously and therefore the electrical connection that causes a ghost touch exists even during the scan of a single pad.) However, this ghost touch can be identified as distinct from the touched pads. Because the ghost touch only occurs when the third corner of the rectangle is touched, the ghost touch must be either the new third touch or the fourth corner of the rectangle. Since the current paths from the pressed pads to the ghost touch are resistive, the combination of the current from touches in the same column and row result in an X-axis reading at the ghost touch that is outside of legal value range. If this illegal value is detected, the touch is considered to be a ghost touch and rejected.

In an alternate embodiment, an actual touch to the fourth corner of a rectangle of touches could be distinguished from a ghost touch, though with very limited functionality. Given that the ghost touch has highly inaccurate pressure and position (i.e., X and/or Y) readings, a specific combination of these readings together with pressure and position readings of one or more pressed pads at one or more other corners of the rectangle could distinguish an actual touch from a ghost touch. In a simple example, an actual touch could be recognized only if the pressure reading of the fourth touch is higher than the pressure readings at both the same row and column of the rectangle, requiring a higher and changing level of force at the fourth touch. If so, the problem of inaccurate X and Y readings could be mitigated by sending fixed X and Y values that reflect the center of the pad. However, in a musical use case, such limited conditions would be impractical and inferior to ignoring the fourth corner touch.

Fortunately, this ghost touch problem is not significant because such grid matrix musical instruments generally arrange the pitches of the pads as on a stringed instrument, with rows usually consisting of consecutive semitone pitches, and with the rows offset by a pitch offset such as a musical fourth interval (5 semitones). This permits multiple instances of each pitch, as on a stringed instrument. Therefore, if a given chord fingering requires a rectangle that produces the ghost touch, there are multiple alternate fingerings of the same chord that don't produce the ghost touch. This approach to avoiding ghost notes can be effective not only for configuration with all small pads but, generally, also for configurations with all pads of the same dimensions, e.g., including large, tall, or wide pads.

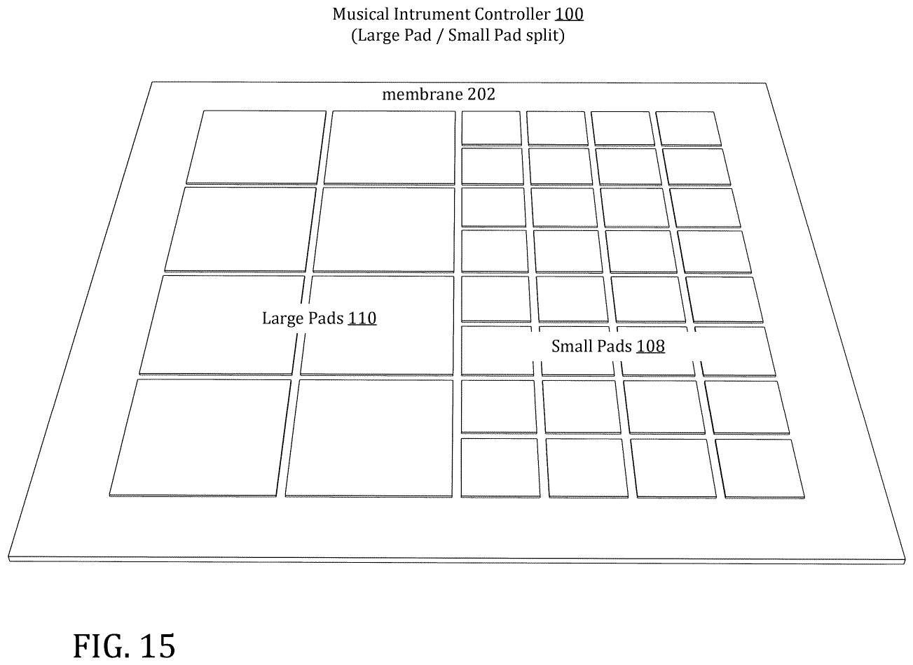

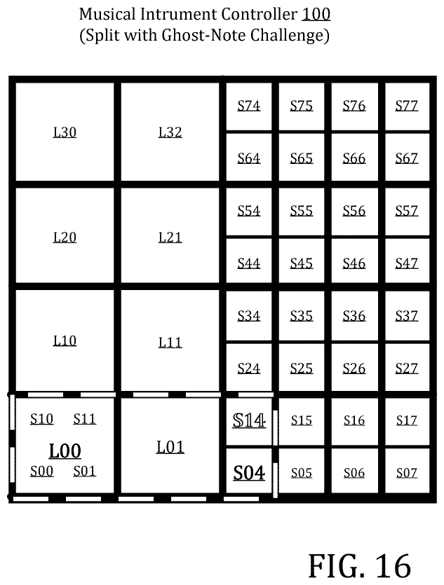

However, mixing different pad size configurations on the same touch surface can increase the likelihood of ghost touches. For example, a musician may wish to play large pads for drum sounds on the left side, while playing small pads for pitched notes and chords on the right side. As shown in FIGS. 15 and 16, MIC 100 can be configured with two columns of large pads on the left and four columns of small pads on the right. In a possible scenario, a full scan for touches includes: 1) a scan of the eight large pads L001-L32 while adjacent pairs of rows and columns are electrically connected; and 2) a scan of the 32 small pads S04-S77 while adjacent rows and adjacent columns are not connected. In this scenario, the adjacent columns on the left side can stay connected, and the adjacent columns on the right side can stay disconnected, while scanning both the left and right sides. Only connected rows affect both sides because they extend fully across the playing surface. Thus, while large pad L00 of FIG. 16 is sampled, a detection results regardless of where on large pad L00 the touch occurs. However, while small pad S14 is sampled, large pad L00 is divided into two electrically separated 1×2 wide pads. If a large pad is touched in the center, the touch will contact both of these 1×2 wide pads (S00+S01, S10+S11).

Thus, while small pad S14 is sampled, if large pad L00 (FIG. 16) is being touched in the center as small pad S04 is sampled, a ghost touch will occur as a result of only two touches: one touching the center of a large virtual pad consisting of two 1×2 wide pads, and one touching a small pad in the same row as one of these wide pads). Further, if more pads are pressed as the same time, additional possibilities for ghost touches exist. However, in a musical instrument, the likelihood of such touch combinations is acceptably low. In the above example of large pads with drum sounds on the left and small pads for pitched notes and chords on the right side, it is unusual for a musician to play complex musical parts on both sides at the same time. It is more likely to alternate between playing drum sounds on the left side and pitched sounds on the right side. The present invention reduces the opportunities for both three-finger three-corners of a rectangle scenarios, and two-finger three-corners of a rectangle scenarios.

Two approaches to reducing two-finger ghost-touch scenarios are detailed below. Both approaches make use of virtual pads that have pad dimensions that differ from the dimensions of underlying electrically-defined pads. In one case, the virtual pads are derived by using software to split the electrically-defined pads; in the other case, the virtual pads are derived by using software to combine electrically-defined pads.

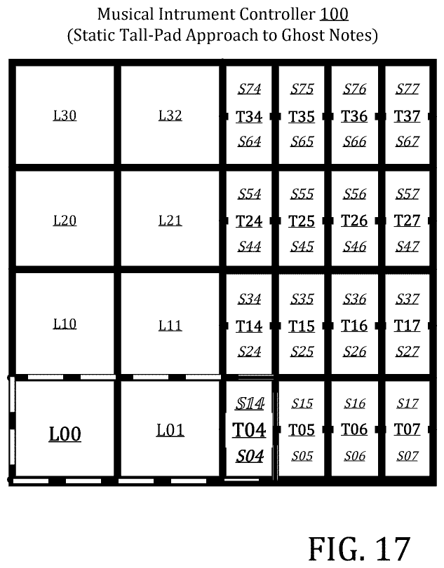

A tall-pad approach includes electrically-defined large pads L00-L32 and electrically-defined tall pads T04-T37 as shown in FIG. 17. Thus, all electrically defined pads involve pairs of electrically connected sensor rows. When, for example, electrically-defined pad T04 is touched, pads S00 and S10 (FIG. 14) are connected and pads S01 and S11 are electrically connected so no 3-corner rectangle results from touching large pad L00 and tall pad T04. However, only one touch is possible on tall pad T04. Once a Y-touch position of tall pad T04 is determined, software can determine whether that Y-position is within virtual small pad S04 or virtual small pad S14 and, for example, sound the intended note. To simplify the musician's understanding of this limitation, he could be instructed to only play the one note at a time on the small pad split, useful for solo play, or the software could impose this limitation. This approach has the advantage that it is relatively simple to implement in software. Alternatively, a dynamic variation of the first approach can be implemented.

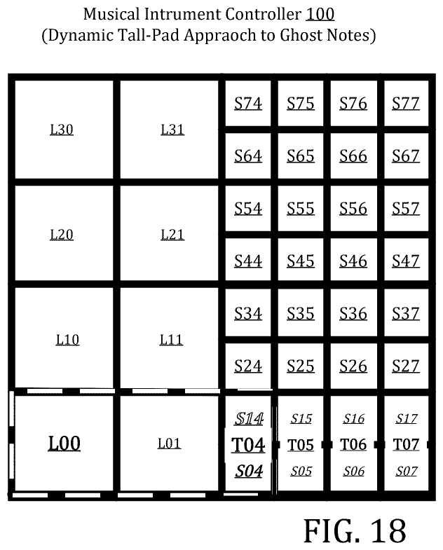

In the dynamic variation of the tall-pad approach, small pads S04-S77 are electrically defined, and no adjacent rows are connected, by default. However, while a large pad is touched in the vertical center, the adjacent rows of the large pad are electrically connected. Thus in FIG. 18, when large pad L00 is touched, tall pads T04-T07 (but not other tall pads) are implemented and virtual small pads S04-S17 are defined in software. This variation has the advantage over the static tall-pad approach in that the tall pad limitation exists only on the same adjacent rows as the touched large pad.

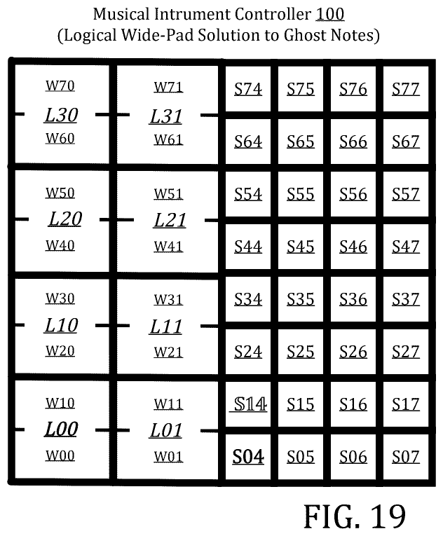

In a wide-pad approach, virtual large pads L00-L31 are software defined by combining pairs of electrically-defined wide pads W00-W71 as indicated in FIG. 19. Small pads S04-S77 are electrically defined. There are two cases to consider: 1) both wide pads (e.g., W00 and W10) are touched, and 2) only one of the two wide pads (W00 or W10) is touched (as a small pad in the same row, e.g., S04, is touched). In the latter case, only two corners of a rectangle are touched, and the ghost-touch problem does not arise. In the former case, the two fingers touch three corners of a rectangle; the ghost-touch problem can be handled by filtering out the ghost touch as in the all-small-pad configuration of FIG. 14. If plural small pads are touched while both wide pads are touched, there can be as many three-corner rectangles as small pads touched. However, this is not a significant problem because it is unlikely that a musician would play multiple large pads on the left side (for example for percussion sounds) while also playing multiple small pads on the right side (for pitched notes and chords). The advantage of this wide-pad approach over the tall-pad approach is that touching two vertically adjacent pads is allowed (since they are not electrically connected) and therefore has the least limitations of the approaches.

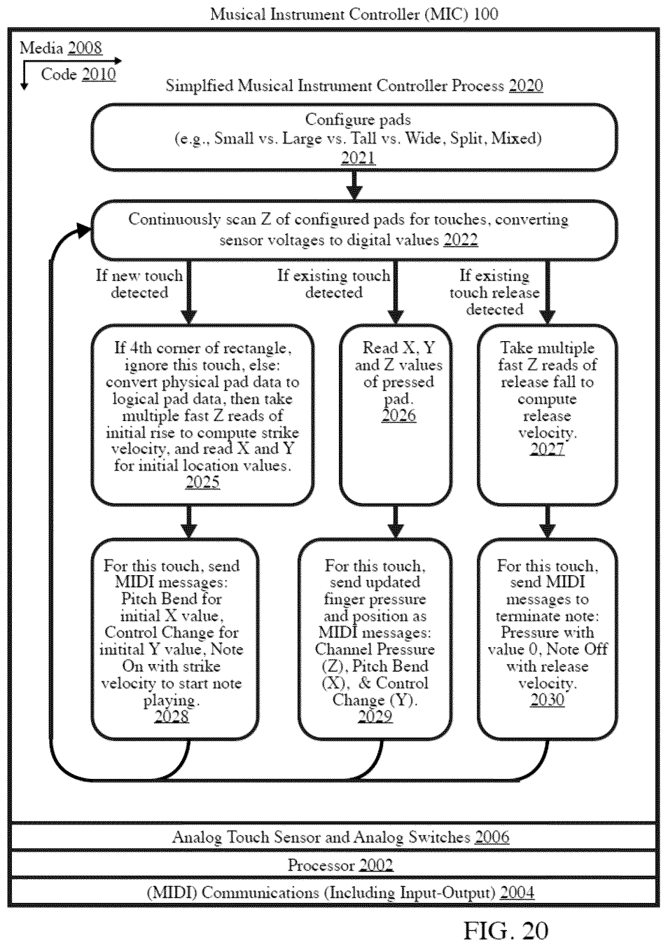

From the computer science perspective of FIG. 20, MIC 100 includes a processor 2002, communications devices 2004, e.g., MIDI and other input/output devices, MIC-specific hardware 2006, e.g., including an analog sensor, analog switches, and an analog-to-digital converter (ADC), and non-transitory computer-readable media 2008. Media 2008 is encoded with code 2010 that, when executed by processor 2002, implements an MIC process 2020.

Process 2020 is basically a more sophisticated version of process 1300, flowcharted in FIG. 13. At 2021, the pads are configured. This configuration corresponds to action 1301 for process 1300; however, in addition to all pads having the same dimensions, split and/or other mixed configurations can be selected. At 2022, the pads (or, more precisely, the corresponding cells) are sequentially and continuously scanned, e.g., by addressing the multiplexers and operating the other analog switches, to electrically connect or disconnect rows and/or columns. In scenarios involving split and other mixed configurations, some reconfigurations, e.g., involving enabling and disabling multiplexers, can be implemented. As the pads are scanned, respective analog voltage levels are sampled and converted to digital values.

If a new touch is detected at 2022, at 2025 it is tested to determine if it is a 4th corner of a rectangle of 3 existing touches and if so, is ignored. Or if it is the 3rd corner of a rectangle with 2 existing touches, the Z values of the 3rd and 4th corners are compared and the pad with the higher value is accepted as a new touch and the 4th corner ignored. Also, while other actions in process 2020 closely track counterparts in process 1300 of FIG. 13, conversion 2025 provides for deriving virtual pad data from physical pad readings at 2022. Following this processing, repeated fast Z measurements are taken to determine a strike velocity value, and initial X and Y positions are also read. Then at 2028, MIDI messages are sent to start a new musical note with pitch number and velocity, for the initial X position, and for the initial Y position. Or if an existing touch is detected at 2022, it is processed at 2026, reading the updated X and Y positions and sending them as updated MIDI X and Y position messages at 2029. Or if the release of an existing touch is detected at 2022, it is processed at 2027, using repeated Z reads as the touch is released to determine the release velocity, which is included in a MIDI message to stop the musical note playing at 2030.

Herein, all art labelled “prior art”, if any, is admitted prior art; all art not labelled “prior art”, if any, is not admitted prior art. The illustrated embodiments, variations thereupon and modifications thereto are provided for by the present invention, the scope of which is defined by the accompanying claims.

What is claimed is:

1. A multi-dimensional-touch controller comprising:
a touch surface;
a matrix sensor comprising a row layer of force-sensitive resistors (FSRs) extending in an X dimension, and a column layer of FSRs extending in a Y dimension, the row layer, the column layer, and the touch surface collectively defining cells that extend parallel to each other in a Z dimension; each cell extending through exactly one force-sensitive resistor extending in the X dimension and through exactly one force-sensitive resistor extending in the Y dimension so that, when a cell is touched at the touch surface, the respective force-sensitive resistors electrically connect;
analog switches having:
a multi-cell pad configuration in which each of plural multi-cell pads of the touch surface extends over at least two cells; and
a single-cell pad configuration in which each of plural 1×1 small pads extends over exactly one cell;
a pressure-read configuration in which a voltage level corresponding to a pressure asserted by touch of a pad is sampled,
a position-read configuration is which a voltage level corresponding to a position of the touch of a pad is sampled; and
a processor for outputting commands based on voltage levels sampled while the analog switches are in the pressure-read and the position-read configurations.

2. The multi-dimensional-touch controller of claim 1 wherein the position read configuration is an X-position read of position along the X-dimension, the analog switches also having a Y-read configuration in which a voltage level corresponding to a Y-position of the touch of the pad is sampled, the commands also being based on voltage levels sampled while the analog switches are in the Y-read configuration.

3. The multi-dimensional-touch controller of claim 1 wherein the matrix sensor includes a spacer that prevents electrical connections between the row and column layers in the absence of a touch of the touch surface.

4. The multi-dimensional-touch controller of claim 3 wherein the spacer includes spacer dots having respective thickness for use in spacing the row layer from the column layer.

5. The multi-dimensional-touch controller of claim 4 wherein the multi-cell pad configuration is a large-pad configuration in which each of plural large pads of the touch surface extends over a 2×2 array of cells, each of the spacer dots being located between adjacent pairs of large pads, directly in the middle of the common edge.

6. The multi-dimensional-touch controller of claim 1 wherein the multi-cell pads are included in a set consisting of 2×2-cell large pads, 2×1-cell tall pads, and 1×2 wide pads.

7. The multi-dimensional-touch controller of claim 1 wherein the analog switches have mixed pad configurations including two different pad dimensions selected for a set consisting of 1×1-cell small pads, 2×2-cell large pads, 2×1-cell tall pads, and 1×2 wide pads.

8. The multi-dimensional-touch controller of claim 7 wherein the mixed pad configurations include a split-pad configuration in which a first set of adjacent columns includes only 1×1-cell small pads, and a second set of columns includes only multi-cell pads.

9. The multi-dimensional-touch controller of claim 8 further comprising non-transitory media encoded with code that, when executed by the processor, derives virtual pads from pads defined by the single-cell or the multi-cell configuration.

10. The multi-dimensional-touch controller of claim 8 wherein the virtual pads are virtual 1×1-cell small pads derived by partitioning 2×1-cell pads defined by the analog switches.

11. The multi-dimensional-touch controller of claim 8 wherein the virtual pads are virtual 2×2-cell large pads derived by combining 1×2-cell wide pads defined by the analog switches.

12. The multi-dimensional-touch controller of claim 1 further comprising non-transitory computer-readable media encoded with code that, when executed using the processor, causes virtual pads to be derived from pads configured by the analog switches, wherein each of the virtual pads extends over a different number of cells than does one of the pads configured by the analog switches.

13. The multi-dimensional-touch controller of claim 12 wherein the virtual pads are 1×1-cell small pads that are derived by partitioning 2×1-cell tall pads configured by the analog switches.

14. The multi-dimensional-touch controller of claim 12 wherein the virtual pads are 2×2-cell large pads that are derived by combining 1×2-cell wide pads configured by the analog switches.

15. The multi-dimensional-touch controller of claim 1 wherein the touch surface is a surface of a membrane that extends over the cells of the matrix sensor, the membrane having shallow grooves and deep grooves, the shallow grooves including shallow row grooves and shallow column grooves, and the deep grooves including deep row grooves and deep column grooves, the deep grooves collectively defining boundaries of 2×2-cell large pads, the deep grooves and shallow grooves collectively defining boundaries of 1×1-cell small pads.

16. A multi-dimensional-touch controller process comprising:
a) reconfiguring the multi-dimensional touch controller having a matrix sensor between single-cell pads and multi-cell pads, the matrix sensor defining the cells, the reconfiguring including reconfiguring analog switches electrically connected to the matrix sensor;
b) detecting touches and pressures and pad positions of the touches;
c) transmitting commands based on the touches and the pressures and pad positions of the touches.

17. The multi-dimensional-touch controller process of claim 16 wherein the commands conform to a Musical Instrument Digital Interface (MIDI) protocol augmented to permit MIDI Polyphonic Expression (MPE).

18. The multi-dimensional-touch controller process of claim 17 further comprising reconfiguring the multi-dimensional touch controller so as to define a split configuration including an array of single-cell pads and a separate array of multi-cell pads.

19. The multi-dimensional-touch controller process of claim 17 wherein the single-cell pads are virtual 1×1-cell small pads derived by partitioning 2×1-cell switched defined 2×1-cell tall pads.

20. The multi-dimensional-touch controller process of claim 17 wherein the multi-cell pads are virtual 2×2-cell large pads derived by combining switched defined 2×1-cell wide pads.

21. The multi-dimensional-touch controller process of claim 16 wherein an actual touch of a pad at the fourth corner of a rectangle is distinguished from a ghost touch of a pad at the fourth corner of the rectangle by comparing the pressure and position values for pads at the first, second and third corners of the rectangle.
